(19) United States
(12) Patent Application Publication
(10) Pub. No.: US 2008/0091879 A1
(43) Pub. Date: Apr. 17, 2008

(54) Method and structure for interruting L2 cache live-lock occurrences

(75) Inventors: Robert J. Dorsey, Durham, NC (US); Jason A. Cox, Raleigh, NC (US); Eric F. Robinson, Raleigh, NC (US); Thuong Q. Truong, Austin, TX (US); Mark J. Wolski, Apex, NC (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/548,829

(22) Filed: Oct. 12, 2006

(51) Int. Cl. G06F 12/00

(52) U.S. Cl. 711/122

(57) ABSTRACT

A system for breaking out of live-locks, the system including: a plurality of central processing units (CPUs), each of the plurality of CPUs having a first level cache; a plurality of second level cache, each of the plurality of second level cache in communication with one or more of the plurality of CPUs; wherein each of the plurality of second level cache includes a plurality of DMs (Data Machines); and wherein the system executes the communication between the plurality of CPUs and the plurality of second level cache by implementing the steps: randomly stopping dispatching of one or more requests; verifying that the plurality of DMs of the second level cache is in an idle state; entering into a single dispatch mode, whereby a DM is dispatched if it is determined that every DM of the second level cache is in the idle state; and returning to normal dispatch mode in a random manner.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to logic circuits, and particularly to a method for addressing live-locks between dispatching.

2. Description of Background

Nearly every modern logic circuit (e.g., a microprocessor) employs a cache whereby some instructions and/or data are kept in storage that is physically closer and more quickly accessible than from main memory. These are commonly known as Level 1 or L1 caches.

In the case of instructions, an L1 cache contains a copy of what is stored in the main memory. As a result, the logic circuit is capable of accessing those instructions more quickly than if it were to wait for memory to provide for such instructions. Like instructions, in the case of data, an L1 cache contains a copy of what is stored in the main memory. However, some L1 designs allow the L1 data cache to sometimes contain a version of the data that is newer than what may be found in main memory. This is referred to as a store-in or write-back cache because the newest copy of the data is stored in the cache and because it is written back out to the memory when that cache location is desired to hold different pieces of data.

Also common among modern microprocessors is a second level cache (i.e., L2 or L2 cache). An L2 cache is usually larger and slower than an L1 cache, but is smaller and faster than memory. So when a processor attempts to access an address (i.e., an instruction or piece of data) that does not exist in its L1 cache, it tries to find the address in its L2 cache. The processor does not typically know where the sought after data or instructions are coming from, for instance, from L1 cache, L2 cache, or memory. The processor simply knows that it is getting what it seeks. The caches themselves manage the movement and storage of data/instructions.

In some systems, there are multiple processors that each have an L1 and that share a common L2 among them. This is referred to as a shared L2. Because such an L2 may have to handle several read and/or write requests simultaneously from multiple processors and even from multiple threads within the same physical processor, a shared L2 cache is usually more complex than a simple, private L2 cache that is dedicated to a single processor. A shared L2 cache typically has some sort of data machines (DMs) to handle the requests that arrive from the multiple processors and threads. The DMs are responsible for searching the L2 cache, returning data/instructions for the sought after address, updating the L2 cache, and requesting data from memory or from the next level of cache if the sought after address does not exist in the L2 cache.

When an op (operation) is being dispatched (i.e., sent to) a DM to be handled, it checks for hazards such as data ordering that would cause data to be moved out of sequence with respect to the program order that was specified by the programmer/compiler. An example of this would be: Op1 is to perform an update and Op2 (which follows Op1 in program order) is to perform a read from the same memory location. Suppose that these ops could not find their address in the L1 cache(s), but the address does exist in the L2 cache. Op2 is not allowed to read the L2 cache until Op1 has completed its update of the L2 cache so that Op2 may correctly “see” the update that was made by Op1. When this hazard occurs, Op2 is rejected or otherwise prevented from being dispatched to a DM. Op2 then tries again to dispatch at some later time. Op2 attempts may continue to be rejected until the Op1 completes enough that the hazard resolves itself.

Another “hazard” that an L2 cache guards against would not result in a data ordering problem as described above, but may cause a performance problem. Like an L1 cache, an L2 cache makes room for new data/instructions from time to time. When an L2 does so, it uses an algorithm to decide which data/instructions to not keep around any longer. One of the most common algorithms is LRU (Least Recently used) whereby, the L2 decides to throw out the address that was last used the longest time ago relative to the other addresses within the set of addresses in the L2 that are trying to make room for the new address. If Op1 were to arrive and be to set G and not be found in the L2 cache, then the L2 cache would make a request to memory to retrieve the contents of the address specified by Op 1. The L2 cache would also choose a line to castout to make room for the new address. It is most likely, the LRU would point to which line to remove. If Op2 were to arrive and also be to set G and also not be found in the L2 cache, but would be to a different line than Op 1, then it would perform all the same steps as Op1. In other words, it would make a request to memory and it would choose a line to castout. However, it would likely choose the same cache location as Op1 for the new address because the LRU had not yet been updated. This would result in either Op1 or Op2 (whichever completed first) being castout as soon as it completed. This, in effect, would defeat the goal of the cache which is to remember the most recently used addresses. When this hazard occurs, Op2 may be rejected or otherwise prevented from being dispatched to a DM. Op2 then tries again to dispatch at some later time. Op2 attempts may continue to be rejected until Op1 completes enough that the hazard resolves itself.

Any particular L2 cache implementation may have other such hazards that would result in ops being prevented from executing and that would cause them to keep retrying until permitted to execute. In either of the above two examples, it may be possible for Op1 to be rejected for some reason and have to retry its request. If it were able to make its retry request before Op2 could make its retry request, then Op2 would again be rejected due to its collision with Op1. It is possible to get into a retry loop where each request is unable to make progress due to another request either going after the same resource or appearing to have an ordering hazard with respect to some other request in the retry loop.

There may be situations when these request-reject-retry sequences do not resolve themselves naturally. This is especially possible when the L2 cache interacts with other masters on the system bus in such a way that L2 requests to memory get into a retry loop. When this occurs, the L2 cache is said to be in a live-lock. Ops appear to be flowing, but none is making forward progress because they keep getting rejected/retried.

Considering the limitations of successfully handling data hazards, it is desirable, therefore, to formulate a method for addressing live-locks between dispatching.

### SUMMARY OF THE INVENTION

The shortcomings of the prior art are overcome and additional advantages are provided through the provision of a system for breaking out live-locks, the system comprising: a plurality of central processing units (CPUs), each of the plurality of CPUs having a first level cache, the first level cache including a copy of information stored in a memory; a plurality of second level cache, each of the plurality of second level cache in communication with one or more of the plurality of CPUs; and a system bus, the bus in communication with the plurality of second level cache; wherein each of the plurality of second level cache includes a plurality of DMs (Data Machines) for handling requests sent from the plurality of CPUs to the plurality of second level cache; and wherein the system executes the communication between the plurality of CPUs and the plurality of second level cache by implementing the steps: randomly stopping dispatching of one or more requests from the plurality of CPUs to the second level cache after a first random period of time within a predetermined range; verifying that each of the plurality of DMs of the second level cache is in an idle state for a predetermined period of time; entering into a single dispatch mode for a second random period of time within a predetermined range, whereby a DM is dispatched if it is determined that every DM of the second level cache is in the idle state; and returning to normal dispatch mode after the second random period of time has ended.

The shortcomings of the prior art are overcome and additional advantages are provided through the provision of a method for breaking out of live-locks in a system having: a plurality of central processing units (CPUs), each of the plurality of CPUs having a first level cache, the first level cache including a copy of information stored in a memory; a plurality of second level cache, each of the plurality of second level cache in communication with one or more of the plurality of CPUs; and a system bus, the bus in communication with the plurality of second level cache, wherein each of the plurality of second level cache includes a plurality of DMs (Data Machines) for handling requests sent from the plurality of CPUs to the plurality of second level cache, the method comprising: randomly stopping dispatching of one or more requests from the plurality of CPUs to the second level cache after a first random period of time within a predetermined range; verifying that each of the plurality of DMs of the second level cache is in an idle state for a predetermined period of time; entering into a single dispatch mode for a second random period of time within a predetermined range, whereby a DM is dispatched if it is determined that every DM of the second level cache is in the idle state; and returning to normal dispatch mode after the second random period of time has ended.

Additional features and advantages are realized through the techniques of the present invention. Other embodiments and aspects of the invention are described in detail herein and are considered a part of the claimed invention. For a better understanding of the invention with advantages and features, refer to the description and the drawings.

### TECHNICAL EFFECTS

As a result of the summarized invention, technically we have achieved a solution that provides for a method for addressing live-locks between dispatching.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a diagram of a live-lock buster system;

FIG. 2 illustrates one example of a diagram of a live-lock buster system depicting requestor processing; and

FIG. 3 illustrates one example of a flowchart for addressing live-locks between dispatching.

### DETAILED DESCRIPTION OF THE INVENTION

One aspect of the exemplary embodiments is a method for addressing live-locks between dispatching. In another aspect of the exemplary embodiments, a set of logic is provided for breaking out of live-locks without knowing whether one exists at any given moment in time. In yet another exemplary embodiment, the breaking out of live-locks is accomplished by randomly stopping the dispatch to any Data machine (DM) within an L2 cache until all the DM's in that L2 cache are idle. Once all the DM's are idle, that L2 cache proceeds to a “single dispatch mode” for a random short period of time, whereby a DM may be dispatched if all the DM's contained within that L2 are idle.

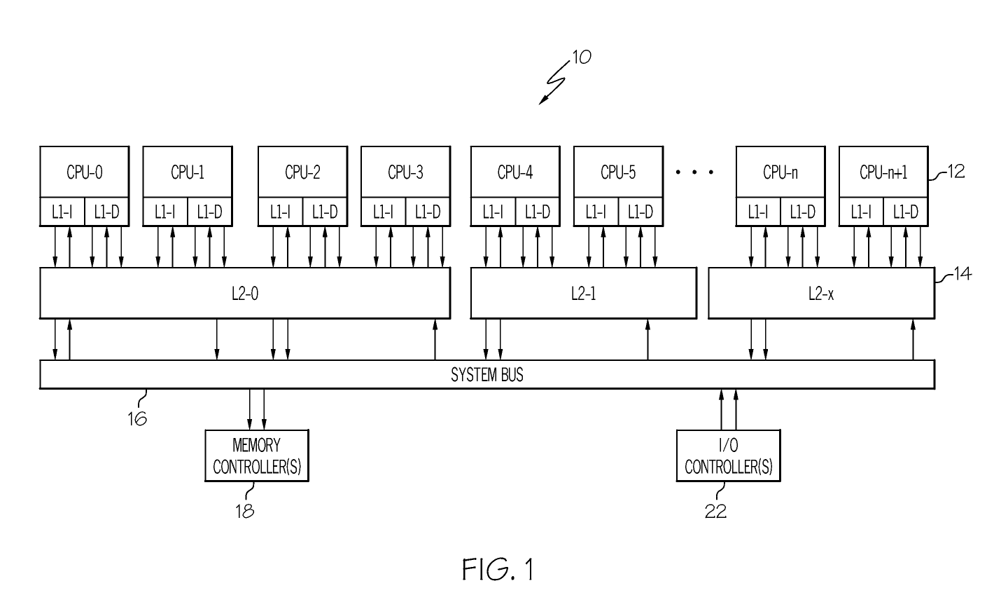

Therefore, because it is difficult to predict ahead of time the live-locks that could occur and because it may be expensive (i.e., complexity and hardware) to detect a live-lock in progress, it is justified to merely assume that live-locks simply occur. As a result of this presumption, the logic is designed to break out of live-locks without knowing whether it's really in one at any given moment in time. The breaking out of live locks is described in detail with regards to FIGS. 1-3 described below.

Referring to FIG. 1, one example of a diagram of a live-lock buster system is illustrated. The system 10 of FIG. 1 includes a plurality of Central Processing Units (CPUs) 12, a plurality of L2 cache 14, a system bus 16, a memory controller 18, and an Input/Output (I/O) Controller 22. One or more of the plurality of CPUs 12 request information from the plurality of cache 14. The I/O controller 22 generates snoop transactions on the system bus 16. The memory controller 18 responds to read and write commands on the bus 16. The plurality of cache 14 are “inclusive L2” caches. In other words, the plurality of cache 14 filters snoops from the system bus 16 and only sends “invalidates” to the L1(s) when necessary. It is important to note that all the cache 14 may be contained on one chip. In another exemplary embodiment, the plurality of cache 14 may be split among several chips (e.g., as in IBM's POWER5™ servers).

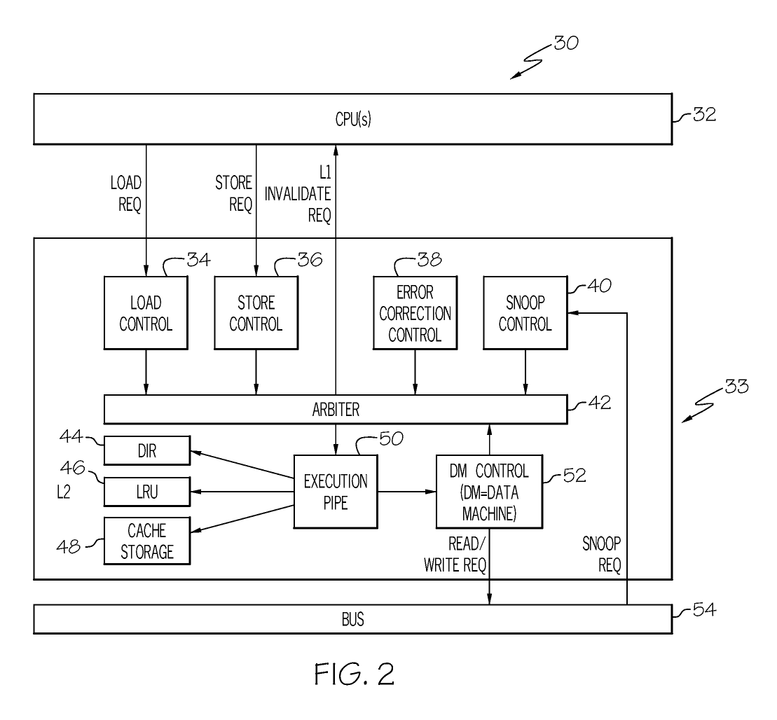

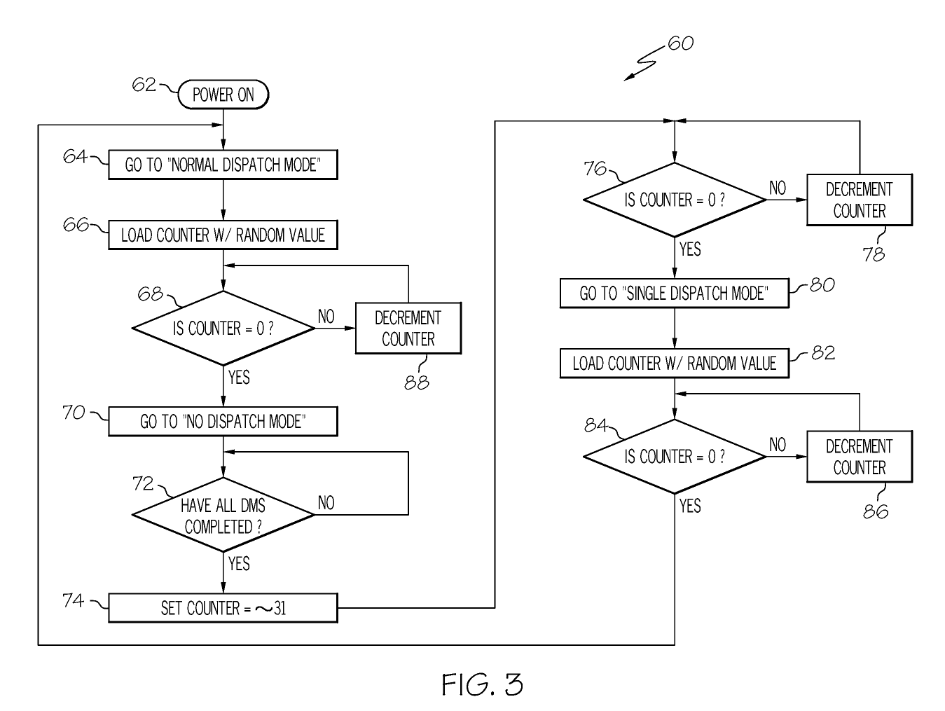

Referring to FIG. 2, one example of a diagram of a live-lock buster system depicting requester processing is illustrated. The system 30 includes a CPU 32, a cache 33, and a bus 54. The cache 33 includes a load control 34, a store control 36, an error correction control 38, a plurality of snoop control 40, an arbiter 42, a DIR (Directory) 44, an LRU (Least Recently Used) 46, a cache storage array 48, an execution pipe 50, and a plurality of DM (Data Machine) control 52. The load control 34 and the store control 36 are in direct communication with the CPU 32. In particular, the load control 34 and the store control 36 manage instructions or information sent from the CPU 32. The load control 34, the store control 36, the error correction control 38, and the snoop control 40 are in direct communication with the arbiter 42. The arbiter 42 orders the computational activities for shared resources in order to prevent concurrent incorrect operations. For example, when two processors request access to a shared memory at approximately the same time, the arbiter 42 puts the requests (e.g., load and store requests) into one order or the other, granting access to only one processor at a time. The output of the arbiter 42 flows into the execution pipe 50. The output of the execution pipe 50 may be further processed by the DIR 44, the LRU 46, or the cache storage array 48. Once the output is further processed by the DIR 44, the LRU 46, or the cache storage array 48, it is directed to one of the plurality of DM control 52. The DM control 52 has the option of directing the output either back into the arbiter 42 or to the bus 54 depending on a variety of reasons such as hazard comparison results or whether or not a counter is set to zero (described in FIG. 3 below).

The following are two live-lock examples illustrating FIGS. 1 and 2 described above. Concerning system conditions, each cache 14 may be shared by 4 processors (the 4 CPUs 12). Each cache 14 may have 16 DM's to handle loads/stores, and each cache 14 may be 1 MB and 8-way set associative with 128 byte lines. Conventions used in the following examples are: Load@A→load from address A; Pi=CPU i, P0 is a first CPU, and P1 is a second CPU.

In the first example, the processors 12 may be polling an address and thus generate a great deal of load traffic to that address. As a result, it is possible for one processor 12 to get locked out and be prevented from polling. Specifically, the following steps may take place:

P0 and P1 each send load@A to a cache 14 (L2) at same time;

P0 wins arbitration to the L2 access execution pipeline;

P1 wins arbitration to the L2 access execution pipeline;

P1's load gets rejected due to a conflict with P0's request. It then proceeds into a load Q to wait for P0's load to finish;

P0's load finishes;

P1's load is asked to retry;

P2 sends load@A to L2 and gets to the arbiter a cycle ahead of when the P1 load is able to make its request;

P2 wins arbitration to the L2 access pipeline;

P1 wins arbitration to the L2 access pipeline;

P1's load gets rejected due to a conflict with P2's request. It then proceeds into the load Q to wait for P2's load to finish;

Each time that it appears that P1 's load is able to get moving through the execution pipeline, another processor slips ahead of it and it ends up being rejected;

At this point, the live-lock breaker alters the conditions a bit, in accordance with the exemplary embodiments of the present invention. For instance, the live lock breaker levels the playing field somewhat by stopping all requests for a period of time, and it ensures that the P1 load and the P2 load requests are seen by the arbiter at the same time. This processing enables the P1 load to win either randomly (given enough head-to-head chances, it'll prevail at some point) or by favoring the older request in the arbiter.

In a second example, the processors 12 may be generating enough new requests to their shared L2 that it cannot complete an older operation. As a result, another L2 may be prevented from gaining access to the line affected by the older operation. Specifically, the following steps may take place:

P0 sends store1@ A to L2-0;

Store1 gets into DM7 (random data machine) and is an L2-0 miss;

Data@A comes into L2-0 and merges with store1's data;

DM7 has ownership of the line and also has the data. It is now ready to write L2-0 cache and L2-0 directory so that it can free up;

P1, P2, P3 & P0 start sending lots of load requests to L2-0;

All are unique addresses and no address conflicts or hazards;

Because processor and system performance is very dependent on load latency, loads have priority over other requests to the cache/directory. Therefore, DM7 keeps requesting access and keeps losing arbitration to the steady stream of new load requests;

P4 sends load1@A to L2-1;

Load1 is an L2-1 miss and L2-1 makes a read request on the system bus which becomes a snoop into the other L2's to see whether they have the data;

L2-0 responds: “retry,” it is not able to service the request because it's to the same line as a DM machine (e.g., DM7) that's trying to update the cache/directory and go idle. L2-0 can't service a snoop for that address until DM7 goes idle;

Each time that L2-1 retries its read request, it gets rejected because DM7 is prevented from completing due to all of the load traffic. It's making requests to the bus, but is not making progress for any request having address A;

So, L2-1 and as a result P4 are prevented from making forward progress due to the volume of load traffic to L2-0 by P0, P1, P2, & P3; and

The live-lock breaker randomly prevents the L2 arbiter from granting requests to gain access to the DM machines. This further stops the loads from being dispatched to DMs and allows the outstanding requests (e.g., DM7 in this case) to complete their processing.

Referring to FIG. 3, one example of a flowchart for addressing live-locks between dispatching is illustrated. The flowchart 60 commences at step 62. In step 62, the dispatching L2 is reset. In step 64, the L2 proceeds to “normal dispatch mode.” In step 66, the counter is loaded with a random value. The random value may be selected by a user to be frequent, medium or rare. This designation by the user influences the magnitude of the random value selected. In step 68, it is determined whether the counter is set to zero. If the counter is not set to zero, then the counter is decremented at step 88. If the counter is set to zero, the process flows to step 70. In step 70, the L2 proceeds to “no dispatch mode.” In other words, no new requests are dispatched to any DMs in that L2 until all the DM's in that L2 are in an idle state. In step 72, it is determined if all the DMs have completed their data/instruction processing. If all the DMs have not completed their data/instruction processing, the process flows back into step 72 until all the DMs in that L2 have processed their data/instruction processing. Once all the DMs have completed their data/instruction processing, the process flows to step 74. In step 74, the counter is set to a predetermined value. In this case, the predetermined value was set at 31. Obviously, the predetermined value may be set to any desired integer. In step 76, it is once again determined whether the counter is set to zero. If the counter is not set to zero, then the counter is decremented at step 78. If the counter is set to zero, the process flows to step 80. In step 80, the L2 proceeds to “single dispatch mode.” In other words, the L2 allows only one DM to be active at a time. In step 82, the counter is loaded with a random value. Once again, the random value may be selected by a user to be frequent, medium or rare. This designation by the user influences the magnitude of the random value selected. In step 84, it is determined whether the counter is again set to zero. If the counter is not zero, then the process flows to step 86, where the counter is decremented. If the counter is zero, then the process flows back to step 64, where the system enters into “normal dispatch mode.”

The exemplary embodiments address live-locks between dispatching DMs. In particular, the dispatching is randomly stopped (e.g., every few 100's of thousands of cycles) to any DM in an L2 until all DMs in that L2 are idle. Once all DMs in that L2 have been idle for a short period of time (e.g., 10's of cycles), go into “single dispatch mode” for a random, short period of time whereby a DM may only be dispatched if all DMs are idle. At the end of that short period of time, return to normal dispatch mode to let multiple DMs be used simultaneously. The reason for this is to periodically provide the DM dispatch with varying situations of system conditions as randomly as possible. Otherwise, it may be possible to get into a significantly large live-lock loop among multiple bus masters.

The exemplary embodiments do not apply only to L2 caches. The processing of the exemplary embodiments may apply to L3 caches, L4 caches, memories, and any other resource that has multiple requestors vying for limited resources.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for breaking out of live-locks, the system comprising:
a plurality of central processing units (CPUs), each of the plurality of CPUs having a first level cache, the first level cache including a copy of information stored in a memory;
a plurality of second level cache, each of the plurality of second level cache in communication with one or more of the plurality of CPUs; and
a system bus, the bus in communication with one or more of the plurality of second level cache;
wherein each of the plurality of second level cache includes a plurality of DMs (Data Machines) for handling requests sent from the plurality of CPUs to the plurality of second level cache; and
wherein the system is configured to execute the communication between the plurality of CPUs and the plurality of second level cache by:
randomly stopping dispatching of one or more requests from the plurality of CPUs to the plurality of second level cache after a first random period of time within a first predetermined range;
verifying that the plurality of DMs of the second level cache is in an idle state for a predetermined period of time;
entering into a single dispatch mode for a second random period of time within a second predetermined range, whereby a DM is dispatched in the event it is determined that every DM of the second level cache is in the idle state; and
returning to normal dispatch mode after the second random period of time within the second predetermined range has ended.

2. The system of claim 1, wherein the plurality of second level cache are in communication with a memory controller and an I/O (Input/Output) controller.

3. The system of claim 1, where the plurality of second level cache are incorporated on one microprocessor.

4. The system of claim 1, wherein the plurality of second level cache are incorporated on a plurality of microprocessors.

5. The system of claim 1, wherein each of the plurality of second level cache includes a load control, a store control, an error correction control, and a plurality of snoop controls in communication with an arbiter.

6. A method for breaking out of live-locks in a system having: a plurality of central processing units (CPUs), each of the plurality of CPUs having a first level cache, the first level cache including a copy of information stored in a memory; a plurality of second level cache, each of the plurality of second level cache in communication with one or more of the plurality of CPUs; and a system bus, the bus in communication with one or more of the plurality of second level cache, wherein each of the plurality of second level cache includes a plurality of DMs (Data Machines) for handling requests sent from the plurality of CPUs to the plurality of second level cache, the method comprising:
randomly stopping dispatching of one or more requests from the plurality of CPUs to the plurality of second level cache after a first random period of time within a first predetermined range;
verifying that the plurality of DMs of the second level cache is in an idle state for a predetermined period of time;
entering into a single dispatch mode for a second random period of time within a second predetermined range, whereby a DM is dispatched in the event it is determined that every DM of the second level cache is in the idle state; and
returning to normal dispatch mode after the second random period of time within the second predetermined range has ended.

7. The method of claim 6, wherein the plurality of second level cache are in communication with a memory controller and an I/O (Input/Output) controller.

8. The method of claim 6, where the plurality of second level cache are incorporated on one microprocessor.

9. The method of claim 6, wherein the plurality of second level cache are incorporated on a plurality of microprocessors.

10. The method of claim 6, wherein each of the plurality of second level cache includes a load control, a store control, an error correction control, and a plurality of snoop controls in communication with an arbiter.
